(19) United States
(12) Patent Application Publication
(10) Pub. No.: US 2026/0141197 A1
(43) Pub. Date: May 21, 2026

(54) SYSTEMS AND METHODS OF UTILIZING QR CODE TO STORE AND PROVIDE INFORMATION RELATED TO PIPELINING USING CIPP

(71) Applicant: PIPE LINING ENTERPRISES, INC., Fort Lauderdale, FL (US)

(72) Inventor: Larry W. Kiest, JR., Fort Lauderdale, FL (US)

(21) Appl. No.: 19/392,545

(22) Filed: Nov. 18, 2025

Related U.S. Application Data
(60) Provisional application No. 63/721,772, filed on Nov. 18, 2024.

(51) Int. Cl. G06K 7/14; G06K 19/06

(52) U.S. Cl. CPC G06K 7/1417; G06K 19/06037

(57) ABSTRACT

Cure-in-place pipe repairs include adding a thin layer of resin, such as put in place with a resin saturated liner, in a pipe and allowing the resin to cure and harden. This creates a new wall for a pipe. For the repair, it is important to know the pipe diameter, any issues with the pipe system, the materials (e.g., resin type and liner information) used, any weather information related to the repair, and any other information that could affect the repair. Such information can be stored on a card or other item that includes a QR code and placed in a cleanout pipe. The QR code can be quickly and easily accessed via any handheld device, such as a smart device, to access the information related to the repaired pipe system.

### CROSS REFERENCE TO RELATED APPLICATIONS

This application claims priority under 35 U.S.C. § 119(e) to provisional patent application U.S. Ser. No. 63/721,772, filed Nov. 18, 2024. The provisional patent application is hereby incorporated by reference in its entirety herein, including without limitation: the specification, claims, and abstract, as well as any figures, tables, appendices, or drawings thereof.

### TECHNICAL FIELD

The present disclosure relates generally to the repair of one or more pipes of a pipe system. More particularly, but not exclusively, the disclosure includes systems and/or apparatus for storing and retrieving information related to the repair of one or more pipes of a pipe system that has been repaired using CIPP.

### BACKGROUND

The background description provided herein gives context for the present disclosure. Work of the presently named inventors, as well as aspects of the description that may not otherwise qualify as prior art at the time of filing, are neither expressly nor impliedly admitted as prior art.

As the infrastructure of major cities and towns in the developed world age, the sewer systems weaken. Pipe degradation, system blockage, water infiltration, and sewer leakage are major problems that aging sewer systems experience. As these problems persist, the sewer system may eventually experience total failure and entire sections of the sewer system may collapse. As a result, sinkholes may form, and sewers may back up into homes and places of business. One method of addressing this critical infrastructure problem is the use of pipelining techniques to rehabilitate existing sewer systems.

Cured-in-place pipelining (CIPP) is one such technique that includes rehabilitating an existing sewer system by creating a new pipe within an existing pipe. A liner, impregnated with a resinous material capable of curing and hardening, is inverted or pulled into a damaged pipe. The liner is pressed against the wall of the existing pipe, and the resinous material is allowed to cure and harden. The result is a replacement pipe having the older pipe or “host pipe” on the exterior. The cured-in-place pipe acts to alleviate the problems caused by structural defects and blockages in the existing sewer system. Even in sewer systems where the main pipes have been rehabilitated with a cured-in-place pipe or other pipe liners, problems still arise.

Conventional sewer lines include a main pipe which extends along the street in a direction parallel to the street. Each house has a lateral pipeline that extends from the home and connects to the main pipeline. U.S. Pat. No. 9,562,339 provides a way in which the lateral pipe is lined using CIPP from a main pipe, which connects to a manhole. Still other patents, such as U.S. Pat. Nos. 9,435,479 and 8,550,121, among others, disclose lining processes.

It is often desirable to provide a clean-out to the lateral pipe adjacent the main sewer pipe. Many lateral pipes have been buried without such a clean-out. One method to provide a clean-out is to make a wide and extensive excavation so that persons can enter the excavation and attach a clean-out pipe to the lateral pipe. This results in considerable disruption to the soil and the yard around the house. Another option utilizes minimally invasive methods, for example, U.S. Pat. Nos. 9,151,410 and 6,705,801 are but some of the ways in which a clean-out is provided to a pipe.

CIPP utilizes a liner tube or tubes saturated with a curable resin, to repair the pipe. The curing of the resin can be made without a heat source by promoting and catalyzing the resin. It is more common to cure the catalyzed resin by using controlled heat such as a steam/air mixture that inflates, expands, and cures the liner.

To best utilize CIPP, a proper order of operations is important. U.S. Pat. No. 11,624,469, which is hereby incorporated by reference in its entirety, discloses an order of operations that will provide the best case for repairing a pipe, which includes the use of a cleanout pipe to provide access to an existing pipe system.

In any case, when a pipe system is repaired, the information related to the repair is important to know. This can include, but is not limited to, pipe size, date and time of repair, any weather considerations, addresses, materials used, company name doing the repair, video of the post pipe rehabilitation as well as any additional information that may be pertinent to the repair. This information may be needed at a later date and time, such as if there are new issues that come up.

There have been some attempts at addressing this issue. For example, U.S. Pat. No. 7,426,941 discloses placing information on the interior of the pipe itself. However, this requires a camera to be inserted to be able to see any such information, and the information is lost as erosion destroys the information. U.S. Pat. No. 9,261,221 discloses use of an RFID transmitter, but this requires a reader inside the pipe to be able to sense and understand the information. Both of these require extensive means to access the pipe in the roadway using expensive equipment and extra manpower and permits with traffic control.

Thus, there exists a need in the art for a system and/or apparatus that is able to store information related to the repair of a pipe system and to be easily and quickly accessed outside of the pipe system.

### SUMMARY

The following objects, features, advantages, aspects, and/or embodiments are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, and/or advantage of the present disclosure to improve on or overcome the deficiencies in the art.

It is a further object, feature, and/or advantage of the present disclosure to provide quick and easy access to information related to the repair of one or more pipes of a pipe system.

It is still yet a further object, feature, and/or advantage of the present disclosure to store information related to the repair of one or more pipes of a pipe system in a database that can be accessed via a QR code. For example, the information can include, but is not limited to, date of repair, address of repair location, materials information (e.g., resin manufacturer and batch information, liner materials, and dimensional information), weather information, installer information, post video of the rehabilitated pipe and any other information related to the repair.

It is yet another object, feature, and/or advantage of the present disclosure to preserve information related to the repair of a pipe system in an easy to access location, such as at a cleanout pipe.

The system and/or apparatus disclosed herein can be used in a wide variety of applications. For example, the use of storing and accessing the information on a card containing a QR code can be placed anywhere at or near the repair of any type of pipe repair.

It is preferred the apparatus be safe, cost effective, and durable. For example, the QR containing apparatus (e.g., a card) can be stored inside a cleanout, but should be durable and maintain the code to be able to access at later times.

At least one embodiment disclosed herein comprises a distinct aesthetic appearance. Ornamental aspects included in such an embodiment can help capture a consumer's attention and/or identify a source of origin of a product being sold. Said ornamental aspects will not impede functionality of the QR containing apparatus.

The QR containing apparatus can be incorporated into systems or kits which accomplish some or all of the previously stated objectives.

According to at least some aspects of the disclosure, an apparatus comprises a substrate; a QR code on the substrate, the QR code connected to a database that includes information related to the repair of one or more pipes of a pipe system using CIPP; wherein the information comprises an address of repair and dimensional information related to the repair; and wherein the substrate is positioned at least partially within a cleanout pipe that connects to the pipe system.

According to at least some embodiments, the substrate is a card.

According to at least some embodiments, the apparatus further comprises a linking member connecting the substrate and the cleanout pipe.

According to at least some embodiments, the linking member is a chain connected to both the substrate and the cleanout pipe.

According to at least some embodiments, the information further comprises date of repair, resin manufacturer and batch information, weather information, installer information, a post video of the rehabilitated pipe, and any other information related to the repair.

According to at least some embodiments, the substrate is a plastic member.

According to at least some embodiments, the substrate is attached using a metal screw.

According to at least some embodiments, the substrate is connected to an interior portion of the cleanout pipe.

According to at least some embodiments, the apparatus further comprises a chain connected to the substrate at one end and mechanically fastened to the interior of the cleanout at the other end.

According to additional aspects, a system comprises a substrate with a QR code thereon; a processing unit including storage; wherein the QR code directs to a location in the storage of the processing unit containing includes information related to the repair of one or more pipes of a pipe system using CIPP; wherein the information comprises an address of repair and dimensional information related to the repair; and wherein the substrate is positioned at least partially within a cleanout pipe used to repair the one or more pipes.

According to at least some embodiments, the substrate comprises a rigid member.

According to at least some embodiments, the system further comprises a linking member connecting the substrate and the cleanout pipe.

According to at least some embodiments, the linking member is a chain connected to both the substrate and the cleanout pipe.

According to at least some embodiments, the information further comprises date of repair, resin manufacturer and batch information, weather information, installer information, post video of the pipe repair, and any other information related to the repair.

According to at least some embodiments, the substrate is connected to an interior portion of the cleanout pipe.

According to at least some embodiments, the storage comprises a database, and the database including the location in the processing unit containing the information related to the repair of one or more pipes of the pipe system.

According to additional aspects, a method comprises accessing a substrate containing a QR code from an interior of a cleanout pipe of a pipe system; scanning the QR code to retrieve information related to repair of one or more pipes of the pipe system; wherein the information comprises an address of repair and dimensional information related to the repair.

According to at least some embodiments, the step of scanning comprises using a smartphone.

According to at least some embodiments, the method further comprises placing the substrate containing the QR code back into the cleanout pipe.

According to at least some embodiments, the information further comprises date of repair, resin manufacturer and batch information, weather information, installer information, post video of the rehabilitated pipe, and any other information related to the repair.

These and/or other objects, features, advantages, aspects, and/or embodiments will become apparent to those skilled in the art after reviewing the following brief and detailed descriptions of the drawings. The present disclosure encompasses (a) combinations of disclosed aspects and/or embodiments and/or (b) reasonable modifications not shown or described.

### BRIEF DESCRIPTION OF THE DRAWINGS

Several embodiments in which the present disclosure can be practiced are illustrated and described in detail, wherein like reference characters represent like components throughout the several views. The drawings are presented for exemplary purposes and may not be to scale unless otherwise indicated.

FIG. 1 is a sectional view of an exemplary sewer system including a manhole, main pipe, and multiple service or lateral pipes.

FIG. 2 is a sectional view showing an exemplary pipe system including a main pipe with a lateral pipe extending to a building and a cleanout providing access to the lateral pipe.

FIG. 3 is an enlarged view of a portion of a cleanout pipe with a cover.

FIG. 4 is a view of the cleanout pipe of FIG. 3 with the cover removed and an identification card attached thereto.

FIG. 5 is a sectional view of the cleanout pipe of FIG. 3 showing the identification card positioned within the pipe.

FIG. 6 is a view of example information that can be stored and accessed via the identification card of the present disclosure.

FIG. 7 is a diagram showing the connections and components of a virtual identification system accessible via a QR code on an identification card according to aspects of the present disclosure.

An artisan of ordinary skill in the art need not view, within isolated figure(s), the near infinite distinct combinations of features described in the following detailed description to facilitate an understanding of the present disclosure.

### DETAILED DESCRIPTION

Unless defined otherwise, all technical and scientific terms used above have the same meaning as commonly understood by one of ordinary skill in the art to which embodiments of the present disclosure pertain.

The terms “a,” “an,” and “the” include both singular and plural referents.

The term “or” is synonymous with “and/or” and means any one member or combination of members of a particular list.

As used herein, the term “exemplary” refers to an example, an instance, or an illustration, and does not indicate a most preferred embodiment unless otherwise stated.

The term “about” as used herein refers to slight variations in numerical quantities with respect to any quantifiable variable. Inadvertent error can occur, for example, through use of typical measuring techniques or equipment or from differences in the manufacture, source, or purity of components.

The term “substantially” refers to a great or significant extent. “Substantially” can thus refer to a plurality, majority, and/or a supermajority of said quantifiable variables, given proper context.

The term “generally” encompasses both “about” and “substantially.”

The term “configured” describes structure capable of performing a task or adopting a particular configuration. The term “configured” can be used interchangeably with other similar phrases, such as constructed, arranged, adapted, manufactured, and the like.

The terms “pipe system”, “main pipe”, “lateral pipe”, “service pipe”, and “cleanout” are intended to mean that which is known in the CIPP industry.

A “pipe liner” is defined as a material that is used to provide a lining to a pipe. Pipe liners include but are not limited to cured-in-place pipe liners, folded liners, or spray-on liners.

A “cured-in-place pipe liner” is a fabric capable of holding a resinous material.

A “folded liner” is a material constructed of a thermoplastic, such as High Pressure Polyethylene (“HPPE”), High Density Polyethylene (“HDPE”), Medium Density Polyethylene (“MDPE”), Polyvinyl Chloride (“PVC”), and/or modified PVC that is used to provide a lining to pipes.

A “main liner” or “main pipe liner” is defined as a pipe liner for use inside of a main sewer pipe.

A “manhole liner” is defined as a material that is used to provide a lining to a manhole. Manhole liners include but are not limited to cured-in-place manhole liners, spray-on manhole liners, cementitious manhole liners, cast-in-place manhole liners, and resin manhole liners.

A “cured-in-place manhole liner” is a fabric or textile capable of holding a resinous material and conforming to a manhole structure

A “spray-on liner” is defined as a material that is used to provide a lining to a manhole or pipe where the material is sprayed onto the walls of the manhole or pipe.

A “cementitious liner” is defined as a cement material that is used to provide a lining to a manhole. Cementitious liners may usually be sprayed, spread, or otherwise placed onto the walls of the manhole.

A “resin liner” is defined as a resinous material that is used to provide a lining to a manhole. Resin liners may be sprayed, spread, or otherwise placed onto the walls of the manhole.

A “service pipe” is defined as a pipe that is lateral to a main pipe.

The terms “residence”, “house”, “building”, or “other structure” are intended to be used interchangeably as a location to which a service or lateral pipe extends from a main pipe to provide sewer services thereto.

Terms characterizing sequential order, a position, and/or an orientation are not limiting and are only referenced according to the views presented.

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

The present disclosure is not to be limited to that described herein. Mechanical, electrical, chemical, procedural, and/or other changes can be made without departing from the spirit and scope of the present disclosure. No features shown or described are essential to permit basic operation of the present disclosure unless otherwise indicated.

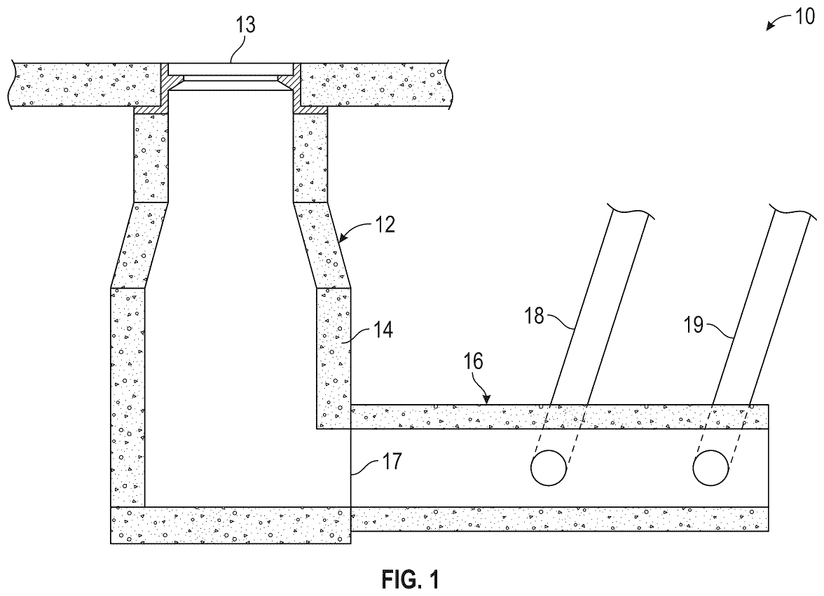

FIG. 1 is an exemplary sectional view of a pipe system 10. The pipe system 10 includes various components which may comprise an exemplary pipe system. However, it should be appreciated that generally any type of pipe system and/or sewage system such as may be used in infrastructure and municipalities, and which may be in need of or have been repair may be considered as part of the disclosure. The pipe system 10 shown in FIG. 1 includes a manhole 12. The manhole 12 includes an opening or access cover 13 to provide access into the manhole 12. The manhole includes walls 14 forming the structure of said manhole 12. Extending from an opening the 17 in a wall 14 of the manhole 12 is a main pipe 16. The main pipe is a term not to be limiting or meaning anything in particular, and instead is included to refer to a specific pipe in the figures. The main pipe includes walls extending a distance from the manhole 12 and may extend from one manhole to another. Generally extending from the main pipe 16 are lateral pipes 18, 19. The lateral pipes 18, 19 may also be referred to as service pipes or user pipes and extend generally from the main pipe 16 to a building, lot, or other location. For example, the lateral pipes may extend from the main pipe 16 to a dwelling, such as a house, building, place of business, or other structure. The lateral pipes are connected in such a manner that the sewage and other fluids flow from the end location, such as the dwelling, towards the main pipe 16.

Many municipalities include such exemplary pipe systems 10 as shown in FIG. 1, and many of said pipe systems have been in place for an extensive period of time. For example, the pipe systems generally comprise concrete, vitrified clay, iron, or the like, and the pipe systems can experience wear and tear. Such wear and tear can take many forms, including, while not limited to, freeze and thaw, leakage, subsidence, water erosion, corrosion, cracking, settling, rusting, plant root intrusion or other, or the like. Any penetration or opening in a pipe can allow groundwater and soil to enter, which can block or otherwise overload the pipe system. Such damage to the structure of the systems require repair. While one type of repair is to dig up the area in and around the pipes and to structurally replace the pipes, this is very costly, disruptive and intrusive. For example, a large amount of ground must be displaced in order to access the underground pipes, then the pipes must be torn out and replaced, then the ground replaced, and the surface restored. Therefore, many times cured-in-place (CIPP) pipelining repair is utilized to repair one or more components (pipe or section or pipe) of the pipe system 10.

CIPP pipe repair, such as is disclosed in U.S. Pat. Nos. 9,562,339, 8,550,121, and 9,435,479, which are hereby incorporated by reference in their entirety, includes inverting a resin impregnated liner into a pipe from outside on inside the pipe, such as within an inflatable bladder. For example, when repairing the main pipe 16, the bladder and liner combination may start in the manhole 12 and be inverted into the main pipe 16 via the opening 17. Otherwise, when repairing the lateral pipes 18, 19, access may be started in the manhole or the main pipe. In either sense, little to no ground is disrupted to provide repair to the pipes. The resin impregnated liner can be cured via an ambient curing agent, a heat source which can be circulated hot water, steam/air mixture, or other (e.g., light, such as ultraviolet light). Currently, steam curing is the most widely used process for curing CIPP. The steam aids in speeding up the curing process of the resin saturated liner in order to provide a new pipe within a pipe that significantly extends the service life of the pipe.

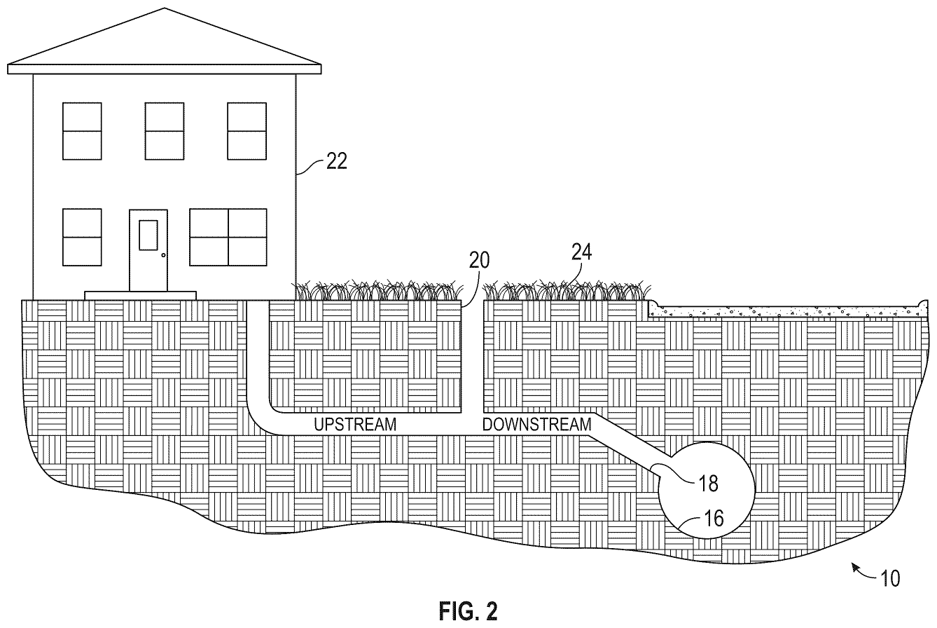

FIG. 2 shows another view of a pipe system 10. As shown in FIG. 2, the pipe system 10 includes a main pipe 16, which is appearing to extend transversely to the surface of the figure. A lateral or service pipe 18 is shown to extend from the main pipe 16 and ultimately ending or connecting with a structure 22. The structure may be any structure having a need for sewer connection, including, but not limited to residences, houses, office buildings, storage buildings, garages, or the like. It should be appreciated that generally any structure having a connection via a pipe system for sewage is to be contemplated. The service or lateral pipe 18 carries material, such as sewage, water, and the like, from the structure 22, through the service pipe 18, and towards the main pipe 16.

The main pipe 16 of the municipality may be connected to multiple structures, such as the structure 22 in the figure, via multiple service pipes along the length of the main pipe 16. From time to time, the main pipe 16, and even some or all of the lateral pipe(s) 18, may need to be repaired, and CIPP repair processes and systems are utilized. This allows for the trenchless and minimally invasive repair of a section or entirety of a pipe or pipes, such as by any of the disclosures referenced and incorporated by reference herein. In addition, to provide access to the pipe system 10 as part of the CIPP process, a cleanout 20 may be needed or otherwise dug to provide access to a lateral pipe 18. A cleanout is created by digging a hole or otherwise removing ground 24 (e.g., via a vacuum system), a hole is created in the lateral pipe at the cleanout, and a saddle or other member can be connected, either temporarily or permanently, to the lateral pipe. Such a process and/or system is shown in U.S. Pat. Nos. 6,705,801; 8,454,271; 8,172,482; all of which are herein incorporated by reference in their entirety. Thus, a cleanout assembly generally comprises a saddle, the riser pipe extending to the ground, and a cover or cap to enclose the cleanout.

Most service lateral pipes, such as the pipe 18 in the figures, do not have a clean out at the property line (i.e., ground 24). The property line is the point where the public right away meets private property, for example the upstream side of a sidewalk could be a property line in a municipality. The process for installing a cleanout 20 can be practiced using ASTM F3097, whereby a minimally invasive sewer cleanout is installed. ASTM F3097 is hereby incorporated by reference in its entirety and for all purposes. Typically, the cleanout connects to the lateral pipe with a TEE shape, providing access both upstream and downstream of the cleanout (see, e.g., FIG. 2 for depiction of upstream/downstream). For reference, ASTM F3097provides the standard for minimally invasive cleanout installation that utilizes a saddle and provides the two-way access.

The newly installed cleanout provides two-way access for both upstream and downstream in the lateral pipeline 18 through a T-shaped clean out that is made by using a pipe saddle, such as that disclosed in any of the referenced and incorporated patents.

The cleanout 20 is used to provide access to the pipe system 10 and to provide additional advantages. For example, equipment, such as cameras and the like, are able to be inserted via the cleanout 20 to monitor the repair process from an upstream location of the repair. In addition, as mentioned herein, a bladder or plug can be inserted through the cleanout 20 and positioned at a location upstream of the cleanout (such as between the cleanout and the structure) to plug or block sewage and any other material from moving from the structure 22, through the lateral/service pipe 18, and into the main pipe 16. This is important during the CIPP process to ensure that the repair retains structural integrity. Municipalities typically are responsible for the maintenance and rehabilitation for service pipes located in the public right away.

As is known, each pipe system, such as that shown in the figures, includes pipes that may comprise different materials, diameters, and issues related to the repair (e.g., cracking, root infiltration, etc.). Different repair companies may use different types of liners, resins, and/or processes to repair the pipes as well. While U.S. Pat. No. 11,624,469 discloses a preferred ordered of operation, this is not always followed. In addition, external factors associated with the repair may be important, such as weather conditions, length of repair, address, and any other issues. This information may need to be referenced at a later time. However, as people and entities change, there may not be a central depository to retrieve this information, such as when further repairs or replacement may be needed.

Additional information or alternative information could be location information, which can include the footage distance of the lateral pipe from the manhole, and/or the location of the connection by clock reference. Still further, GPS coordinates could be used instead of an actual address.

Therefore, as will be understood, the present disclosure includes apparatus, systems, and/or methods for storing and retrieving information related to the repair of one or more pipes of a pipe system, such as that shown in FIGS. 1-2. Aspects and/or embodiments of the present disclosure will provide improvements for the access of the information related to the pipe repair.

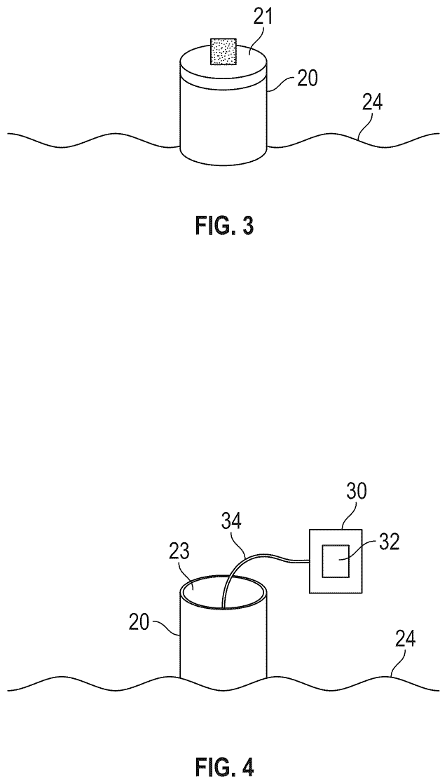

Moving now to FIGS. 3-5, portions of a cleanout pipe 20 relative to the ground 24 is shown. As shown, a portion of the cleanout pipe 20 may extend outward of the ground 24. However, it should be appreciated that the cleanout 20 may terminate generally at ground level as well. To close the cleanout pipe 20 and to mitigate access thereto, a lid or cover 21 can be provided. The cover 21 can be threaded, friction fit, or otherwise temporarily affixed in place relative to a terminal portion of the cleanout pipe 20. The cover 21 can also be locked in place to restrict access to the interior of the cleanout, such as by unauthorized people.

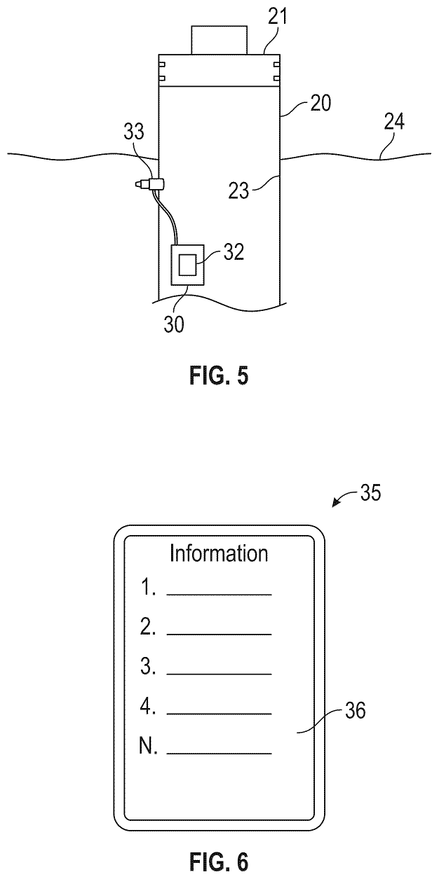

FIG. 4 shows the cover 21 removed from the cleanout pipe 20, which shows or provides access to an interior of the cleanout pipe 20. As shown, there is an identification card 30 that is affixed or attached to a portion of the cleanout pipe 20. For example, as shown in FIG. 5, the identification card 30 can be attached to a portion of the interior 23 of the cleanout pipe 20 by way of mechanical or non-mechanical fastener 33.

In general, a mechanical fastener is a device that is used to mechanically join or fasten two or more objects together. In general, fasteners are used to create non-permanent joints or connections; that is, joints that can be removed or dismantled without damaging the joining components. General types of mechanical fasteners can include threaded (bolts, screws, nuts, studs, etc.) or non-threaded (keys, pins, retaining rings, etc.). Additional fasteners can include, but are not limited to nails, rivets, and the like. Non-mechanical fasteners may include adhesives, fittings, clearance fittings, friction fittings, compression fittings, transition fittings, snaps, snap fits, hook and loops, joints, and the like. For simplistic purposes, screws, nuts, bolts, pins, rivets, staples, washers, grommets, latches (including pawls), ratchets, clamps, clasps, flanges, ties, adhesives, welds, any other known fastening mechanisms, or any combination thereof may be used to facilitate fastening, may be used for any of the connections described herein and all are to be considered swappable with one another for any of the attachment, connection, and/or fastening of components, either temporarily or permanently. It is further considered that any combination of any of the listed mechanical and/or non-mechanical fasteners or methods of fastening are to be considered a part of the disclosure.

Any way of connecting the identification card 30 to the interior 23 of the cleanout pipe 20 is to be considered a part of the present disclosure. For example, it is also considered that the card 30 could be attached directly to the cleanout, such as via a mechanical or non-mechanical fastener. This could include an adhesive on the card or connecting the card to a portion of the cleanout. Magnets could also be used.

According to at least some embodiments, the figures show a linking member in the form of a connector 34 connecting the identification card 30 to the pipe 20. The connector 34 can be a chain, rope, strap, tether, or any other component that connects at one end to a portion of the identification card 30 and to the interior 23 of the pipe 20 at the other end. Furthermore, the length of the connector 34 may vary and can be any length.

The identification card 30 is a substrate that will contain a QR code that provides a link to information related to the repair of one or more pipes of the pipe system. The card 30 can be generally any material that allows for the printing or attachment of a QR code and any additional information. According to some embodiments, the substrate of the card 30 may be plastic, but it should be appreciated that generally any other material can be utilized as the substrate. This can be steel, metals, plastics, paper, cardboard, wood, composites, or generally any material that may be able to withstand differing weather and/or environmental conditions within the pipe.

The card 30 is referred to as a substrate in that it can be a conduit in which a QR code and other information can be placed. For example, as will be understood, the QR code can be positioned on the substrate to direct a user to information. Additional information can be logos, URLs, other identifying indicia, or generally anything. The information can be placed on the substrate in the form of a sticker, can be etched into the substrate, can be formed as part of an additive manufacturing process (i.e., 3D printing), or any other manner.

The placement of the card 30 within a portion of the interior 23 of the cleanout pipe 20 provides advantages. This is a known location for placing such information for a future user to be able to find information related to the repair of one or more pipes of the pipe system. Inside the pipe will also protect and shield the card 30 from external conditions, such as weather, graffiti, damage, etc. Having the card connected via the linking member 34 will also provide conformity for the industry in that anyone in the future will know exactly how and where to look for the information provided.

As noted, the card 30 will include information, such as a QR code 32 thereon. A QR code (quick-response code) is a type of two-dimensional matrix barcode. It features black squares on a white background with fiducial markers, readable by imaging devices like cameras, and processed using Reed-Solomon error correction until the image can be appropriately interpreted. The required data is then extracted from patterns that are present in both the horizontal and the vertical components of the QR image.

Whereas a barcode is a machine-readable optical image that contains information specific to the labeled item, the QR code contains the data for a locator, an identifier, and web-tracking. To store data efficiently, QR codes use four standardized modes of encoding: (I) numeric, (ii) alphanumeric, (iii) byte or binary, and (iv) kanji. Compared to standard UPC barcodes, the QR labeling system was applied beyond the automobile industry because of faster reading of the optical image and greater data-storage capacity in applications such as product tracking, item identification, time tracking, document management, and general marketing.

As is known, typically, a smartphone or other smart device is used as a QR code scanner, displaying the code and converting it to some useful form (such as a standard URL for a website, thereby obviating the need for a user to type it into a Web browser).

Therefore, as part of the present disclosure, the QR code 32 on the card 30 can be used to direct a user to a website or other domain that includes information specific to the repair of one or more pipes of the pipe system in the vicinity of the QR code 32. For example, as shown best in FIG. 6, once the QR code 32 has been accessed, such as via a smart device (e.g., a smart phone), a link can be provided for site that shows information 36, which can be on the smart device 35. For purposes of the present disclosure, a smart device 35 can be considered as any electronic device, generally connected to other devices or networks via different wireless protocols (such as Bluetooth, Zigbee, near-field communication, Wi-Fi, NearLink, Li-Fi, or 5G) that can operate to some extent interactively and autonomously. As noted, the smart device 35 may need a camera or scanner to be able to scan and “read” the QR code 34 on the card 30, as well as some sort of network protocol to access the database storing the information.

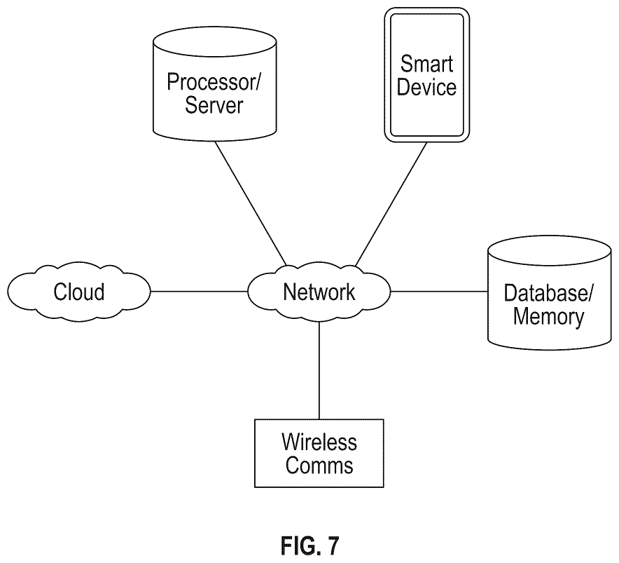

FIG. 7 is an example of a site, such as a URL, that has been accessed via a QR code from a card. The site and/or information can be accessed and viewed via a display 36 on a smart device, such as a smart phone 35. While any piece of information related to the repair of one or more pipes can be shown, for example purposes, the following can be considered: address of the repair (including the address of any structures in communication with one of the pipes that have been repaired), length of cleanout, repair liner dimensions (thickness, diameter, and/or length), date of installation/repair, resin information (manufacturer and batch), video of installation, installer information (name and contact information), contractual information related to the repair, weather conditions during repair, a notes section with any additional information, etc. Note that there is no limitation on either end for the amount of information. As shown in FIG. 6, the list of information ends with N, where N is any number greater than 1. This indicates that there is any amount of information that can be provided for later retrieval.

The information stored and accessed can be useful at a later date so as to address any issues or for inspection purposes. The information could be used at a later date to test the conditions to improve future repairs using the same or similar processes.

As shown in FIG. 7, a number of components will comprise a system incorporating the card with QR code directing to the repair information. Once a repair has taken place, the installer or someone else associated with the repair can enter the information into a storage, such as database comprising memory. This can be on a server or other processing unit. The database will include a specific location, such as a website, URL, or other accessible site (such an any non-transitory computer readable medium), and associate the same with a generated QR code, which is then added to the card.

In communications and computing, a computer readable medium is a medium capable of storing data in a format readable by a mechanical device. The term “non-transitory” is used herein to refer to computer readable media (“CRM”) that store data for short periods or in the presence of power such as a memory device.

The system will include access, such as wireless access, to an intelligent control (i.e., a controller) and components for establishing communications. Examples of such a controller may be processing units alone or other subcomponents of computing devices. The controller can also include other components and can be implemented partially or entirely on a semiconductor (e.g., a field-programmable gate array (“FPGA”)) chip, such as a chip developed through a register transfer level (“RTL”) design process.

A processing unit, also called a processor, is an electronic circuit which performs operations on some external data source, usually memory or some other data stream. Non-limiting examples of processors include a microprocessor, a microcontroller, an arithmetic logic unit (“ALU”), and most notably, a central processing unit (“CPU”). A CPU, also called a central processor or main processor, is the electronic circuitry within a computer that carries out the instructions of a computer program by performing the basic arithmetic, logic, controlling, and input/output (“I/O”) operations specified by the instructions. Processing units are common in tablets, telephones, handheld devices, laptops, user displays, smart devices (TV, speaker, watch, etc.), and other computing devices.

As noted, the information related to the repair of one or more pipes of a pipe system can be stored via memory in a database for later retrieval. The memory includes, in some embodiments, a program storage area and/or data storage area. The memory can comprise read-only memory (“ROM”, an example of non-volatile memory, meaning it does not lose data when it is not connected to a power source) or random access memory (“RAM”, an example of volatile memory, meaning it will lose its data when not connected to a power source). Examples of volatile memory include static RAM (“SRAM”), dynamic RAM (“DRAM”), synchronous DRAM (“SDRAM”), etc. Examples of non-volatile memory include electrically erasable programmable read only memory (“EEPROM”), flash memory, hard disks, SD cards, etc. In some embodiments, the processing unit, such as a processor, a microprocessor, or a microcontroller, is connected to the memory and executes software instructions that are capable of being stored in a RAM of the memory (e.g., during execution), a ROM of the memory (e.g., on a generally permanent basis), or another non-transitory computer readable medium such as another memory or a disc.

The database is a structured set of data typically held in a computer. The database, as well as data and information contained therein, need not reside in a single physical or electronic location. For example, the database may reside, at least in part, on a local storage device, in an external hard drive, on a database server connected to a network, on a cloud-based storage system, in a distributed ledger (such as those commonly used with blockchain technology), or the like.

Still further, as noted, the database may be accessed via a smart device scanning or reading the QR code to access the remote database. This can include use of a wireless network, utilizing any protocols. In some embodiments, the network is, by way of example only, a wide area network (“WAN”) such as a TCP/IP based network or a cellular network, a local area network (“LAN”), a neighborhood area network (“NAN”), a home area network (“HAN”), or a personal area network (“PAN”) employing any of a variety of communication protocols, such as Wi-Fi, Bluetooth, ZigBee, near field communication (“NFC”), etc., although other types of networks are possible and are contemplated herein. The network typically allows communication between the communications module and the central location during moments of low-quality connections. Communications through the network can be protected using one or more encryption techniques, such as those techniques provided by the Advanced Encryption Standard (AES), which superseded the Data Encryption Standard (DES), the IEEE 802.1 standard for port-based network security, pre-shared key, Extensible Authentication Protocol (“EAP”), Wired Equivalent Privacy (“WEP”), Temporal Key Integrity Protocol (“TKIP”), Wi-Fi Protected Access (“WPA”), and the like.

Therefore, as can be appreciated, the system can be utilized in a number of ways. For example, after one or more pipes of a pipe system have been repaired, the installer/repairer enters any of the selected information into a database and creates a QR code that links to the database. The QR code is then added to a card or other substrate. The card is then connected to an interior portion of a cleanout pipe associated with the pipe system, such as by mechanically fastening a linking member connecting the card to the cleanout pipe. The lid or cover to the pipe can then be positioned to close the cleanout pipe.

At a later time, the QR code can be accessed by removing the cover to the cleanout pipe and the card or substrate removed. A smart device (such as a smartphone, tablet, or other handheld with a camera) is used to scan/read the QR code. This provide a link or connection to the database, URL, or other location housing the repair information. Such information can be shown on a display of the smart device. The information can be reviewed and utilized, as needed.

After, the card with QR code can be replaced in the interior of the cleanout pipe and the cover can be replaced, thus preserving the card with QR code for later access.

While a QR code on a substrate has been disclosed, it should be appreciated that other forms of storing and accessing the information are part of the disclosure. For example, according to at least some aspects and/or embodiments, instead of a QR code on a substrate, near field communication (NFC) devices could be used to transmit information from a device that is stored in the pipe system and accessed to access information. Still further, RFID could be used to access information that is stored related to the pipe system. It should be noted that any or all of the following could be used to store and access the information.

Near Field Communication (NFC)—NFC is a set of communication protocols that enable two electronic devices to communicate when they are within 4 cm of each other. It allows for instant data transfer with a simple tap, ideal for contactless payments and information sharing.

Radio Frequency Identification (RFID)—RFID uses electromagnetic fields to automatically identify and track tags attached to objects. It can be passive (powered by the RFID reader) or active (battery-powered). This technology uses radio waves to identify and track information using radio tags and readers. The tag is identified by transmitting its unique identifier to the RFID tag reader.

Barcodes—Barcodes encode data in a visual format that machines can read.

Bluetooth Low Energy (BLE) Beacons—Bluetooth low-energy beacons are primarily used for proximity marketing, indoor navigation, and asset tracking. They excel at low power consumption and accurate indoor positioning and can interact seamlessly with mobile apps.

SnapTags—SnapTags are a form of 2D mobile barcode. Like QR Codes, SnapTags require users to scan using their mobile device. The user has to snap a picture of the code and then text the photo to a short code indicated on the SnapTag. Users can also download a SnapTag reader to directly scan the tag.

Data Matrix—Of the alternatives available, a data matrix is the most visually similar to QR Codes. It is a 2D barcode that encodes data in a square or rectangular pattern of black and white cells. It can hold alphanumeric data, numbers, and special characters.

Still additional features according to at least some embodiments include additional information on the substrate/card. For example, the card could have a QR code as well as information directly on one or more sides of the card, which can include a caution or notice that a pipe has been repaired using a resin-saturated liner. This could indicate to someone in the future that they should not use caustic acid in the pipe or to not use cable machines to clean the pipe, as this could damage the repaired pipe.

Advantages to the system include, but are not limited to, unfettered access to the repair information. Anyone who has access to a cleanout pipe is able to scan the QR code to review the information related to the repair of a pipe. Such information can be useful, such as when further repairs are needed or when the installer needs contacted for further information. For example, any authorized person (such as a city employee) can access the information with nothing more than a wrench or other tool to open the lid and a smart device (e.g., smartphone) that is able to access the pertinent information related to the interior of the pipe or other structure.

Additional advantages include ease of access to the information. While previous solutions have printed information on the liner, this can dissolve or erode over time. As the QR code directs to a database or memory location that is remote, this should always be available.

While aspects and/or embodiments of the disclosure have been directed towards pipes and pipe systems, it should be noted that the infrastructure should not be limited as such. For example, there are many infrastructures, buildings, or locations where access is limited and/or the information is not readily available. This can include utilities structures (e.g., water towers or filtration systems) wherein certain information is held at a municipal location (e.g., city hall). Still other infrastructures, such as vaults and conduits could also benefit from using the apparatuses or systems disclosed.

For example, utilities structures can include water towers, which are drained, cleaned, and/or repainted/coated from time to time. After any repairs or cleaning has taken place, the water tower is refilled and the interior is not accessible. Information related to the cleaning and/or repair may be stored at a municipal building, such as dates, what was done, who completed the tasks, and any applications (i.e., information related to the painting or coating applied). However, this may not be a readily accessible location for a person called to the structure. Therefore, having an apparatus that includes a QR code that leads to an accessible database via a smartphone, tablet, or other smart device that includes the information will provide the advantage of providing the information on an as-needed basis as the location of need.

Likewise, vaults, which may include burial vaults or any other vault, are generally closed and non-accessible after they are complete. However, information related to the building of the vault (materials, dates, weather, etc.) as well as any of the contents of the vault (names, descriptions, etc.) may be unknown. If any information is provided, it may be light on content. Therefore, the apparatus with QR code that leads to a trove of information would provide benefits so far unseen for these structures as well.

It should be appreciated that any structure could utilize an apparatus with QR code that leads to information, even if accessible, as this information can be preserved in a medium that allows instantaneous accessibility and preservation that could far outlive the structure itself.

Therefore, systems, methods, and/or apparatus for saving and providing access to repair information for one or more pipes of a pipe system have been shown and/or described. It should be noted that the information is not to be limiting in any manner. Still further, it should be appreciated that any of the aspects of any of the embodiments can be combined with any of the other aspects, even those not explicitly disclosed herein, to create additional embodiments and/or aspects of the disclosure, including those not explicitly described.

1. An apparatus, comprising:
a substrate;
a QR code on the substrate, the QR code connected to a database that includes information related to the repair of one or more pipes of a pipe system using CIPP;
wherein the information comprises information related to the repair; and
wherein the substrate is connected to a cleanout connected to at least one pipe of the pipe system.

2. The apparatus of claim 1, wherein the information includes the address of the rehabilitated pipe.

3. The apparatus of claim 1, wherein the information includes dimensional information.

4. The apparatus of claim 1, wherein the substrate is positioned at least partially within the cleanout.

5. The apparatus of claim 1, wherein the substrate is attached to the cleanout.

6. The apparatus of claim 1, wherein the substrate is a card.

7. The apparatus of claim 1, further comprising a linking member connecting the substrate and the cleanout pipe.

8. The apparatus of claim 7, wherein the linking member is a chain connected to both the substrate and the cleanout pipe.

9. The apparatus of claim 1, wherein the information further comprises date of repair, materials information, installer information, and any other information related to the repair.

10. The apparatus of claim 1, wherein the information further comprises a video showing the rehabilitated pipe, and any other information related to the pipe repair.

11. The apparatus of claim 1, wherein the substrate is a plastic member.

12. The apparatus of claim 1, wherein the substrate comprises a metal.

13. The apparatus of claim 1, wherein the substrate comprises an adhesive.

14. The apparatus of claim 1, wherein the substrate is connected to an interior portion of a cleanout assembly comprising a saddle, a riser pipe, and a cap.

15. The apparatus of claim 8, further comprising a chain connected to the substrate at one end and mechanically fastened to the interior of the cleanout at the other end.

16. A system, comprising:
a substrate with a QR code thereon;
a processing unit including storage;
wherein the QR code directs to a location in the storage of the processing unit containing includes information related to the repair of one or more pipes of a pipe system using CIPP;
wherein the information comprises an address of repair and dimensional information related to the repair; and
wherein the substrate is positioned at least partially within a cleanout used to repair the one or more pipes of the pipe system.

17. The system of claim 16, wherein the substrate comprises a rigid member.

18. The system of claim 16, further comprising a linking member connecting the substrate and the cleanout pipe.

19. The system of claim 18, wherein the linking member is a chain connected to both the substrate and the cleanout pipe.

20. The system of claim 16, wherein the information further comprises date of repair, installer information, and any other information related to the repair.

21. The system of claim 16, wherein the information further comprises information related to the CIPP materials, and information related to the size of the CIPP, and any other information related to the repair.

22. The system of claim 16, wherein the substrate is connected to or attached to an interior portion of the cleanout pipe.

23. The system of claim 16, wherein the storage comprises a database, and the database including the location in the processing unit containing the information related to the repair of one or more pipes of the pipe system.

24. A method, comprising:
accessing a substrate containing a QR code from an interior of a cleanout assembly of a pipe system;
scanning the QR code to retrieve information related to repair of one or more pipes of the pipe system;
wherein the information comprises identification of a location of the repair and dimensional information related to the repair.

25. The method of claim 24, wherein the step of scanning comprises using a smart device.

26. The method of claim 24, further comprising placing the substrate containing the QR code back into the cleanout pipe.

27. The method of claim 24, wherein the information further comprises size of a CIPP, address of the repair, and any other information related to the repair.

28. The method of claim 24, wherein the information further comprises a caution mark to alert users that the pipe has been rehabilitated with a CIPP.

29. The method of claim 24, wherein the information further comprises a video of the rehabilitated pipe, and any other information related to the repair.
